(19) United States
(12) Patent Application Publication
(10) Pub. No.: US 2013/0297439 A1
(43) Pub. Date: Nov. 7, 2013

(54) Computer-Based Marketplace for E-Procurement

(71) Applicant: Jean-Marie Chanoine, New York, NY (US)

(72) Inventor: Jean-Marie Chanoine, New York, NY (US)

(73) Assignee: First Lumen, Inc., New York, NY (US)

(21) Appl. No.: 13/830,110

(22) Filed: Mar. 14, 2013

Related U.S. Application Data
(60) Provisional application No. 61/642,588, filed on May 4, 2012.
(60) Provisional application No. 61/678,567, filed on Aug. 1, 2012.

(51) Int. Cl. G06Q 30/06

(52) U.S. Cl. CPC G06Q 30/0641
USPC 705/26.3; 705/27.1; 705/26.35; 705/26.4

(57) ABSTRACT

Provided are computer-based systems, software, and computer-implemented methods for providing a marketplace for e-procurement that leverages asymmetric market forces to the benefit of an advantaged market participant. Such a marketplace additionally, creates a synergistic effect by offering a wide range of procurement methods.

### CROSS-REFERENCE TO RELATED APPLICATIONS

This application claims the benefit of U.S. Application Ser. No. 61/642,588, filed May 4, 2012, and U.S. Application Ser. No. 61/678,567, filed Aug. 1, 2012, each of which is hereby incorporated by reference in its entirety.

### BACKGROUND OF THE INVENTION

E-procurement (also known as supplier exchange) is the purchase and sale of supplies and services through the Internet or other information and networking systems. Traditionally, e-procurement web sites allow users to look for buyers or sellers of goods and services and specify prices or invite bids.

### SUMMARY OF THE INVENTION

Current e-procurement systems, products, and services fail to account for the fact that market forces are often asymmetrical. Existing systems are not designed to allow a dominant market participant to leverage asymmetries. Moreover, existing systems fail to offer a wide range of purchasing options forcing participants to utilize formats that do not fully take advantage of their market position. Importantly, existing e-procurement systems fail to effectively overcome language barriers and, as a result, unnecessarily limit markets. Last, existing e-procurement systems, products, and services fail to adequately transfer knowledge of transactions and participating parties from individual buyers/sellers to institutional databases.

Advantages of the systems, media, software, applications, and methods described herein include allowing dominant market participants to leverage asymmetrical market forces. Specifically, advantages include, but are not limited to, offering closed market options with an opportunity to pre-screen subordinate participants, aggregating a wide range of e-commerce formats, including negotiated sales, and fostering efficient competition by informing participants of relevant market activity. An additional advantage of the systems, media, software, applications, and methods described herein is expansion of markets and opportunities by offering a cross-lingual platform wherein suppliers create and maintain product definitions in a plurality of language and negotiations are optionally facilitated by the participation of language translators. Moreover, the systems, media, software, applications, and methods described herein advantageously transfers ownership of institutional knowledge from individuals doing the buying or selling to the owner of the market, e.g., an advantaged buyer or seller. Any agent of an advantaged buyer or seller is able to mine the system to study prior interaction with a given counterpart.

Accordingly, in one aspect, disclosed herein are computer-implemented systems comprising: a digital processing device comprising an operating system configured to perform executable instructions and a memory device; a computer program including instructions executable by the digital processing device to create a marketplace for a central buyer comprising: a database of product definitions, wherein each definition is submitted and/or maintained by a supplier of the product; a software module configured to allow the central buyer and one or more suppliers to negotiate on the terms of sale of one or more defined products; and a software module configured to provide a contextual sale information ticker. In some embodiments, the marketplace is for online procurement of commoditized products by the central buyer. In some embodiments, the central buyer is a single company. In other embodiments, the central buyer is a plurality companies with a common interest. In some embodiments, the marketplace is a private marketplace and each supplier is invited to participate in the marketplace by the central buyer. In some embodiments, the software module configured to allow the central buyer and one or more suppliers to negotiate on the terms of sale of one or more defined products allows negotiation on numeric terms. In some embodiments, the software module configured to allow the central buyer and one or more suppliers to negotiate on the terms of sale of one or more defined products allows negotiation one or more of: price, quantity, and delivery date. In some embodiments, the marketplace further comprises a software module configured to allow a supplier to configure one or more offers, wherein an offer comprises one or more defined products and terms of sale. In some embodiments, the marketplace further comprises a software module configured to allow a central buyer to procure products from the suppliers by direct purchase. In some embodiments, the marketplace further comprises a software module configured to allow a central buyer to procure products from the suppliers by reverse auction. In some embodiments, the marketplace further comprises a software module configured to allow a central buyer to pre-screen and invite one or more suppliers to participate in the marketplace. In further embodiments, the central buyer invites about 3 to about 5000 suppliers to participate in the marketplace. In some embodiments, the marketplace further comprises a software module configured to allow a supplier to submit product definitions. In further embodiments, the software module configured to allow a supplier to submit product definitions requires each product definition to be associated with a classification defined by a central buyer. In further embodiments, the software module configured to allow a supplier to submit product definitions allows each product definition to be associated with a current capacity. In further embodiments, the software module configured to allow a supplier to submit product definitions allows each product definition to be associated with a cost structure. In further embodiments, the software module configured to allow a supplier to submit product definitions allows a supplier to submit each product definition in a plurality of languages. In some embodiments, the marketplace further comprises a software module configured to create a chat session between the central buyer, one or more suppliers and one or more language translators. In further embodiments, the chat session is scheduled. In other embodiments, the chat session is on-demand. In some embodiments, the marketplace further comprises a software module configured to aggregate all communications related to a transaction and associate them with a pending or completed transaction. In further embodiments, the communications associated with a pending or completed transaction are viewable only by users associated with the transaction or associated with the parties to the transaction. In some embodiments, the contextual sale information ticker displays information on recent sales made in the marketplace, wherein the ticker displays the information to suppliers. In further embodiments, the contextual sale information ticker displays information to each supplier participating in the marketplace that is limited to information on recent sales of products sold by each particular supplier. In further embodiments, the contextual sale information ticker displays information to each supplier participating in the marketplace that is limited to information on recent sales designated by the central buyer. In some embodiments, the computer program comprises a web application. In further embodiments, the web application is commercialized as software-as-a-service (SaaS). In some embodiments, the computer program comprises a mobile application.

In another aspect, disclosed herein are computer readable storage media encoded with a computer program including instructions executable by a digital processing device to create a private marketplace for a central buyer comprising: a database of product definitions, wherein each definition is submitted and/or maintained by a supplier of the product, wherein each supplier is invited to participate in the marketplace by the central buyer; a software module configured to allow the central buyer and one or more suppliers to negotiate on the terms of sale of one or more defined products; and a software module configured to provide a contextual sale information ticker. In some embodiments, the marketplace is for online procurement of commoditized products by the central buyer. In some embodiments, the central buyer is a single company. In other embodiments, the central buyer is a plurality companies with a common interest. In some embodiments, the software module configured to allow the central buyer and one or more suppliers to negotiate on the terms of sale of one or more defined products allows negotiation on numeric terms. In some embodiments, the software module configured to allow the central buyer and one or more suppliers to negotiate on the terms of sale of one or more defined products allows negotiation one or more of: price, quantity, and delivery date. In some embodiments, the marketplace further comprises a software module configured to allow a supplier to configure one or more offers, wherein an offer comprises one or more defined products and terms of sale. In some embodiments, the marketplace further comprises a software module configured to allow a central buyer to procure products from the suppliers by direct purchase. In some embodiments, the marketplace further comprises a software module configured to allow a central buyer to procure products from the suppliers by reverse auction. In some embodiments, the marketplace further comprises a software module configured to allow a central buyer to pre-screen and invite one or more suppliers to participate in the marketplace. In further embodiments, the central buyer invites about 3 to about 5000 suppliers to participate in the marketplace. In some embodiments, the marketplace further comprises a software module configured to allow a supplier to submit product definitions. In further embodiments, the software module configured to allow a supplier to submit product definitions requires each product definition to be associated with a classification defined by a central buyer. In further embodiments, the software module configured to allow a supplier to submit product definitions allows each product definition to be associated with a current capacity. In further embodiments, the software module configured to allow a supplier to submit product definitions allows each product definition to be associated with a cost structure. In further embodiments, the software module configured to allow a supplier to submit product definitions allows a supplier to submit each product definition in a plurality of languages. In some embodiments, the marketplace further comprises a software module configured to create a chat session between the central buyer, one or more suppliers and one or more language translators. In further embodiments, the chat session is scheduled. In other embodiments, the chat session is on-demand. In some embodiments, the marketplace further comprises a software module configured to aggregate all communications related to a transaction and associate them with a pending or completed transaction. In further embodiments, the communications associated with a pending or completed transaction are viewable only by users associated with the transaction or associated with the parties to the transaction. In some embodiments, the contextual sale information ticker displays information on recent sales made in the marketplace, wherein the ticker displays the information to suppliers. In further embodiments, the contextual sale information ticker displays information to each supplier participating in the marketplace that is limited to information on recent sales of products sold by each particular supplier. In further embodiments, the contextual sale information ticker displays information to each supplier participating in the marketplace that is limited to information on recent sales designated by the central buyer. In some embodiments, the computer program comprises a web application. In further embodiments, the web application is commercialized as software-as-a-service (SaaS). In some embodiments, the computer program comprises a mobile application.

In another aspect, disclosed herein are computer-implemented methods for e-procurement comprising the steps of: providing a database of product definitions, wherein each definition is submitted and/or maintained by a supplier of the product, wherein each supplier is invited to participate in a private marketplace by a central buyer; providing a software module configured to allow the central buyer and one or more suppliers to negotiate on the terms of sale of one or more defined products; and providing a software module configured to provide a contextual sale information ticker. In some embodiments, the method is for online procurement of commoditized products by the central buyer. In some embodiments, the central buyer is a single company. In other embodiments, the central buyer is a plurality companies with a common interest. In some embodiments, the software module configured to allow the central buyer and one or more suppliers to negotiate on the terms of sale of one or more defined products allows negotiation on numeric terms. In some embodiments, the software module configured to allow the central buyer and one or more suppliers to negotiate on the terms of sale of one or more defined products allows negotiation one or more of: price, quantity, and delivery date. In some embodiments, the method further comprises the step of providing a software module configured to allow a supplier to configure one or more offers, wherein an offer comprises one or more defined products and terms of sale. In some embodiments, the method further comprises the step of providing a software module configured to allow a central buyer to procure products from the suppliers by direct purchase. In some embodiments, the method further comprises the step of providing a software module configured to allow a central buyer to procure products from the suppliers by reverse auction. In some embodiments, the marketplace further comprises a software module configured to allow a central buyer to pre-screen and invite one or more suppliers to participate in the marketplace. In further embodiments, the central buyer invites about 3 to about 5000 suppliers to participate in the marketplace. In some embodiments, the method further comprises the step of providing a software module configured to allow a supplier to submit product definitions. In further embodiments, the software module configured to allow a supplier to submit product definitions requires each product definition to be associated with a classification defined by a central buyer. In further embodiments, the software module configured to allow a supplier to submit product definitions allows each product definition to be associated with a current capacity. In further embodiments, the software module configured to allow a supplier to submit product definitions allows each product definition to be associated with a cost structure. In further embodiments, the software module configured to allow a supplier to submit product definitions allows a supplier to submit each product definition in a plurality of languages. In some embodiments, the method further comprises the step of providing a software module configured to create a chat session between the central buyer, one or more suppliers, and one or more language translators. In further embodiments, the chat session is scheduled. In other embodiments, the chat session is on-demand. In some embodiments, the method further comprises the step of providing a software module configured to aggregate all communications related to a transaction and associate them with a pending or completed transaction. In further embodiments, the communications associated with a pending or completed transaction are viewable only by users associated with the transaction or associated with the parties to the transaction. In some embodiments, the contextual sale information ticker displays information on recent sales made in the marketplace, wherein the ticker displays the information to suppliers. In further embodiments, the contextual sale information ticker displays information to each supplier participating in the marketplace that is limited to information on recent sales of products sold by each particular supplier. In further embodiments, the contextual sale information ticker displays information to each supplier participating in the marketplace that is limited to information on recent sales designated by the central buyer.

In another aspect, disclosed herein are computer-implemented methods for e-procurement comprising the steps of: screening, by a central buyer, one or more product suppliers; inviting one or more screened product suppliers to participate in a private online marketplace; reviewing product definitions created by each product supplier, wherein the product definitions are stored in a computer memory; providing, by one or more processors, a contextual sale information ticker to each product supplier; and purchasing, by one or more processors, one or more defined products by direct purchase, reverse auction, or negotiated purchase.

In another aspect, disclosed herein are computer-implemented systems comprising: a digital processing device comprising an operating system configured to perform executable instructions and a memory device; a computer program including instructions executable by the digital processing device to create a marketplace for a central supplier comprising: a database of buyers; a database of product definitions, wherein each definition is submitted and/or maintained by the central supplier; a software module configured to allow the central seller and one or more buyers to negotiate on the terms of sale of one or more defined products; and a software module configured to provide a contextual sale information ticker. In some embodiments, the central supplier is a single company. In other embodiments, the central supplier is a plurality companies with a common interest. In some embodiments, the marketplace is a private marketplace and each buyer is invited to participate in the marketplace by the central supplier. In some embodiments, the software module configured to allow the central supplier and one or more buyers to negotiate on the terms of sale of one or more defined products allows negotiation on numeric terms. In some embodiments, the software module configured to allow the central supplier and one or more buyers to negotiate on the terms of sale of one or more defined products allows negotiation one or more of: price, quantity, and delivery date. In some embodiments, the marketplace further comprises a software module configured to allow a buyer to configure one or more offers, wherein an offer comprises one or more defined products and terms of sale. In some embodiments, the marketplace further comprises a software module configured to allow a central supplier to sell products by direct purchase. In some embodiments, the marketplace further comprises a software module configured to allow a central supplier to sell products by auction. In some embodiments, the marketplace further comprises a software module configured to allow a central supplier to pre-screen and invite one or more buyers to participate in the marketplace. In further embodiments, the central supplier invites about 3 to about 5000 buyers to participate in the marketplace. In some embodiments, the marketplace further comprises a software module configured to allow a supplier to submit product definitions. In further embodiments, the software module configured to allow a supplier to submit product definitions allows a supplier to submit each product definition in a plurality of languages. In some embodiments, the marketplace further comprises a software module configured to create a chat session between the central supplier, one or more buyers and one or more language translators. In further embodiments, the chat session is scheduled. In other embodiments, the chat session is on-demand. In some embodiments, the marketplace further comprises a software module configured to aggregate all communications related to a transaction and associate them with a pending or completed transaction. In further embodiments, the communications associated with a pending or completed transaction are viewable only by users associated with the transaction or associated with the parties to the transaction. In some embodiments, the contextual sale information ticker displays information on recent sales made in the marketplace, wherein the ticker displays the information to buyers. In further embodiments, the contextual sale information ticker displays information to each buyer participating in the marketplace that is limited to information on recent sales of products recently bought by each particular buyer. In further embodiments, the contextual sale information ticker displays information to each buyer participating in the marketplace that is limited to information on recent sales designated by the central supplier. In some embodiments, the computer program comprises a web application. In further embodiments, the web application is commercialized as software-as-a-service (SaaS). In some embodiments, the computer program comprises a mobile application.

In another aspect, disclosed herein are computer-implemented methods for e-procurement comprising the steps of: screening, by a central supplier, one or more buyers; inviting one or more screened buyers to participate in a private online marketplace; uploading product definitions created by the central supplier, wherein the product definitions are stored in a computer memory; providing, by one or more processors, a contextual sale information ticker to each buyer; and selling, by one or more processors, one or more defined products by direct sale, auction, or negotiated sale.

### BRIEF DESCRIPTION OF THE DRAWINGS

FIG. 1 shows a non-limiting example of a marketplace for e-procurement, in this case, a supplier's perspective of a database of products with definitions submitted by the supplier.

FIG. 2 shows a non-limiting example of a marketplace for e-procurement, in this case, a supplier's perspective of a database of products with definitions submitted by the supplier including a new product detail.

FIG. 3 shows a non-limiting example of a marketplace for e-procurement, in this case, a supplier's perspective of an interface for managing database of contact requests.

FIG. 4 shows a non-limiting example of a marketplace for e-procurement, in this case, a supplier's perspective of a database of contact requests including a new contact request screen.

FIG. 5 shows a non-limiting example of a marketplace for e-procurement, in this case, a supplier's perspective of an interface for a software module configured to allow a supplier to configure one or more offers.

FIG. 6 shows a non-limiting example of a marketplace for e-procurement, in this case, a supplier's perspective of an interface for a software module configured to allow a supplier to configure one or more offers including a new offer screen.

FIG. 7 shows a non-limiting example of a marketplace for e-procurement, in this case, a supplier's perspective of an interface for a software module configured to allow a supplier to configure auctions including a list of auctions.

FIG. 8 shows a non-limiting example of a marketplace for e-procurement, in this case, a supplier's perspective of an interface for a software module configured to allow a supplier to configure auctions including an auction product detail screen.

FIG. 9 shows a non-limiting example of a marketplace for e-procurement, in this case, a supplier's perspective of an interface for a software module configured to allow a supplier to configure auctions including an auction detail screen.

FIG. 10 shows a non-limiting example of a marketplace for e-procurement, in this case, a supplier's perspective of an interface for a software module configured to allow a central buyer to procure products from the suppliers by reverse auction including a bid screen.

FIG. 11 shows a non-limiting example of a marketplace for e-procurement, in this case, a supplier's perspective of an interface for a software module configured to allow a buyer and a supplier to negotiate on the terms of sale of defined products.

FIG. 12 shows a non-limiting example of a marketplace for e-procurement, in this case, a supplier's perspective of an interface for a software module configured to allow a buyer and a supplier to negotiate on the terms of sale of defined products including a negotiation detail screen.

FIG. 13 shows a non-limiting example of a marketplace for e-procurement, in this case, a supplier's perspective of an interface for a software module configured to allow a supplier to review and manage orders placed by a buyer.

FIG. 14 shows a non-limiting example of shows a non-limiting example of a marketplace for e-procurement, in this case, a buyer's perspective of an interface for a software module configured to allow a supplier to configure one or more offers.

FIG. 15 shows a non-limiting example of shows a non-limiting example of a marketplace for e-procurement, in this case, a buyer's perspective an interface for a software module configured to allow a supplier to configure one or more offers including an offer detail screen.

FIG. 16 shows a non-limiting example of shows a non-limiting example of a marketplace for e-procurement, in this case, a buyer's perspective of an interface that displays a seller defined product to the buyer.

FIG. 17 shows a non-limiting example of shows a non-limiting example of a marketplace for e-procurement, in this case, a buyer's perspective of an interface for a software module configured to allow a buyer to procure products from suppliers by reverse auction.

FIG. 18 shows a non-limiting example of shows a non-limiting example of a marketplace for e-procurement, in this case, a buyer's perspective of an interface for a software module configured to allow a buyer to procure products from suppliers by reverse auction including an auction record editing screen.

FIG. 19 shows a non-limiting example of shows a non-limiting example of a marketplace for e-procurement, in this case, a buyer's perspective of an interface for a software module configured to allow a buyer to procure products from suppliers by reverse auction including an auction winners selection screen.

FIG. 20 shows a non-limiting example of shows a non-limiting example of a marketplace for e-procurement, in this case, a buyer's perspective of an interface for a software module configured to allow a buyer and one or more suppliers to negotiate on the terms of sale of one or more defined products.

FIG. 21 shows a non-limiting example of shows a non-limiting example of a marketplace for e-procurement, in this case, a buyer's perspective of an interface for a software module configured to allow a buyer and one or more suppliers to negotiate on the terms of sale of one or more defined products including a negotiation detail screen.

FIG. 22 shows a non-limiting example of shows a non-limiting example of a marketplace for e-procurement, in this case, a buyer's perspective of an interface for a software module configured to allow a buyer to review and manage orders placed by suppliers.

FIG. 23 shows a non-limiting example of shows a non-limiting example of a marketplace for e-procurement, in this case, a buyer's perspective of an interface for managing database of contact requests.

### DETAILED DESCRIPTION OF THE INVENTION

Current e-procurement systems, products, and services are not designed to allow a dominant market participant to leverage asymmetrical market forces. For example, many existing systems do not offer closed market options with an opportunity to pre-screen participants or features to foster competition by providing information on market activity to subordinate parties. Moreover, existing systems offer limited purchasing options and fail to include features that facilitate or even allow negotiation between market participants. Last, existing e-procurement systems fail to effectively overcome language barriers and, as a result, unnecessarily limit markets.

Accordingly, described herein, in various embodiments, are computer-implemented systems comprising: a digital processing device comprising an operating system configured to perform executable instructions and a memory device; a computer program including instructions executable by the digital processing device to create a marketplace for a central buyer comprising: a database of product definitions, wherein each definition is submitted and/or maintained by a supplier of the product; a software module configured to allow the central buyer and one or more suppliers to negotiate on the terms of sale of one or more defined products; and a software module configured to provide a contextual sale information ticker.

Described herein, in various embodiments, are computer readable storage media encoded with a computer program including instructions executable by a digital processing device to create a private marketplace for a central buyer comprising: a database of product definitions, wherein each definition is submitted and/or maintained by a supplier of the product, wherein each supplier is invited to participate in the marketplace by the central buyer; a software module configured to allow the central buyer and one or more suppliers to negotiate on the terms of sale of one or more defined products; and a software module configured to provide a contextual sale information ticker.

Described herein, in various embodiments, are computer-implemented methods for e-procurement comprising the steps of: providing a database of product definitions, wherein each definition is submitted and/or maintained by a supplier of the product, wherein each supplier is invited to participate in a private marketplace by a central buyer; providing a software module configured to allow the central buyer and one or more suppliers to negotiate on the terms of sale of one or more defined products; and providing a software module configured to provide a contextual sale information ticker.

Described herein, in various embodiments, are computer-implemented methods for e-procurement comprising the steps of: screening, by a central buyer, one or more product suppliers; inviting one or more screened product suppliers to participate in a private online marketplace; reviewing product definitions created by each product supplier, wherein the product definitions are stored in a computer memory; providing, by one or more processors, a contextual sale information ticker to each product supplier; and purchasing, by one or more processors, one or more defined products by direct purchase, reverse auction, or negotiated purchase.

Described herein, in various embodiments, are computer-implemented systems comprising: a digital processing device comprising an operating system configured to perform executable instructions and a memory device; a computer program including instructions executable by the digital processing device to create a marketplace for a central supplier comprising: a database of buyers; a database of product definitions, wherein each definition is submitted and/or maintained by the central supplier; a software module configured to allow the central seller and one or more buyers to negotiate on the terms of sale of one or more defined products; and a software module configured to provide a contextual sale information ticker.

Described herein, in various embodiments, are computer-implemented methods for e-procurement comprising the steps of: screening, by a central supplier, one or more buyers; inviting one or more screened buyers to participate in a private online marketplace; uploading product definitions created by the central supplier, wherein the product definitions are stored in a computer memory; providing, by one or more processors, a contextual sale information ticker to each buyer; and selling, by one or more processors, one or more defined products by direct sale, auction, or negotiated sale.

### Certain Definitions

Unless otherwise defined, all technical terms used herein have the same meaning as commonly understood by one of ordinary skill in the art to which this invention belongs.

As used in this specification and the appended claims, the singular forms “a,” “an,” and “the” include plural references unless the context clearly dictates otherwise. Any reference to “or” herein is intended to encompass “and/or” unless otherwise stated.

As used herein, “e-procurement” refers to a form of business-to-business, business-to-consumer, or business-to-government e-commerce, wherein the purchase and sale of supplies, work, and services are initiated or completed via the web or other computer-based networks.

As used herein, “product” refers to any good, work, right, or service. Products are not limited to any particular use or any particular industry.

As used herein, “negotiation” refers to a dialogue between two or more people or parties regarding a term of sale of one or more products. In some embodiments, terms of sale include, by way of non-limiting examples, price, quantity, product properties, delivery date, and warranty.

### Marketplace

Disclosed herein, in some embodiments, are systems, media, software, applications, and methods for providing marketplace allowing a dominant market participant to leverage asymmetrical market forces by providing a closed (e.g., private) market. In some embodiments, the dominant market participant is a central buyer. In other embodiments, the dominant market participant is a central supplier. In still further embodiments, the systems, media, software, applications, and methods disclosed herein include further features allowing a dominant market participant to leverage their position including, by way of non-limiting examples, invitation to participate controlled by the dominant participant, multiple purchase options (direct, negotiated, reverse auction, etc.), language translation, and a sale ticker to let each non-advantaged participant know what terms of sale are successful with the dominant market participant.

Many applications of such a closed (e.g., private) market are suitable and contemplated by the inventions described herein. By way of example, in trade markets, this optionally involves an association of minority suppliers (e.g., a trade associations, a chamber of commerce, etc.) setting up market where large corporate members buy from small minority businesses members. By way of further example, this optionally involves the wholesale business, particularly a small business only market. By way of still further example, this optionally involves a marketplace for e-procurement.

Disclosed herein, in some embodiments, are systems, media, software, applications, and methods for providing a marketplace for e-procurement. In some embodiments, the marketplace is configured to allow an advantaged market participant to leverage or capitalize upon asymmetric market forces. In such cases, supply, demand, and/or other market forces (e.g., new market entrants, substitute products, supplier bargaining power, and buyer bargaining power) are not balanced creating an advantaged or dominant position for one or more market participants. In some embodiments, the marketplace is configured to allow an advantaged buyer to leverage or capitalize upon asymmetric market forces. In other embodiments, the marketplace is configured to allow an advantaged supplier to leverage or capitalize upon asymmetric market forces.

In some embodiments, the marketplace a private (e.g., closed) market. In further embodiments, an advantaged market participant grants access to a private marketplace to one or more other market participants. In still further embodiments, an advantaged market participant invites one or more other market participants to participate in a private marketplace. An advantaged market participant grants access to a private marketplace in a variety of ways. In various embodiments, suitable methods of granting access include, by way of non-limiting examples, providing a non-public URL and providing user credentials (e.g., a username and/or password). In some embodiments, the marketplace comprises a software module configured to allow an advantaged market participant to invite one or more other market participants to participate in the marketplace. In further embodiments, invitations are made, for example, by email, voice mail, phone call, instant message, SMS, MMS, fax, or the like. In some embodiments, the software module configured to allow invitation also allows an advantaged market participant to screen one or more other market participants prior to inviting them to participate in the marketplace. In further embodiments, screening or pre-screening is performed on the basis of factors including, by way of non-limiting examples, performance history, capacity, performance guaranties and/or warranties, reputation, financial metrics (e.g., credit rating, revenue, stock performance, etc.), insurance status, survey results, and the like. In some embodiments, one or more market participants apply to an advantaged market participant for admission to a private marketplace. In some embodiments, accepting an invitation to participate in a marketplace requires execution of an agreement to terms of use specified by an advantaged market participant.

In some embodiments, an advantaged market participant is a central buyer. In further embodiments, a central buyer invites suppliers to participate in a private marketplace. In various embodiments, a central buyer invites 1, 2, 3, 4, 5, 6, 7, 8, 9, 10 or more suppliers to participate. In other various embodiments, a central buyer invites 10, 20, 30, 40, 50, 60, 70, 80, 90, 100 or more suppliers, including increments therein, to participate. In other various embodiments, a central buyer invites 100, 200, 300, 400, 500, 600, 700, 800, 900, 1000 or more suppliers, including increments therein, to participate. In other various embodiments, a central buyer invites 1000, 2000, 3000, 4000, 5000, 6000, 7000, 8000, 9000, 10000 or more suppliers, including increments therein, to participate.

In some embodiments, a central buyer invites, by way of non-limiting examples, about 1 to about 100, about 100 to about 1000, or about 1000 to about 10000 suppliers to participate.

In some embodiments, an advantaged market participant is a central supplier. In further embodiments, a central supplier invites buyers to participate in a private marketplace. In various embodiments, a central supplier invites 1, 2, 3, 4, 5, 6, 7, 8, 9, 10 or more buyers to participate. In other various embodiments, a central supplier invites 10, 20, 30, 40, 50, 60, 70, 80, 90, 100 or more buyers, including increments therein, to participate. In other various embodiments, a central supplier invites 100, 200, 300, 400, 500, 600, 700, 800, 900, 1000 or more buyers, including increments therein, to participate. In other various embodiments, a central supplier invites 1000, 2000, 3000, 4000, 5000, 6000, 7000, 8000, 9000, 10000 or more buyers, including increments therein, to participate. In some embodiments, a central supplier invites, by way of non-limiting examples, about 1 to about 100, about 100 to about 1000, or about 1000 to about 10000 buyers to participate.

In some embodiments, the marketplace is a public (e.g., open) market. In further embodiments, market participants are free to participate in the marketplace without prior screening, invitation, or grant of access.

In some embodiments, the marketplace is a business-to-business marketplace, wherein the participants are businesses. In some embodiments, the marketplace is a business-to-consumer marketplace, wherein a central supplier provides goods and/or services to individual consumers. In some embodiments, the marketplace is a business-to-government marketplace, wherein a central buyer procures goods and/or services from one or more government entities. In some embodiments, the marketplace is a business-to-government marketplace, wherein a central supplier provides goods and/or services to one or more government entities.

The marketplace suitably offers a wide range of methods for commerce. In some embodiments, the marketplace offers tools and features allowing an advantaged market participant to select a method of commerce that best leverages asymmetrical market forces in a given situation. In various embodiments, the marketplace offers options for, by way of non-limiting examples, direct purchase, auctions, reverse auctions, negotiated purchase, and the like. In further embodiments, by aggregating a wide range of methods for commerce/transactions, the marketplace creates a synergistic effect not previously available to advantaged market participants. In some embodiments, a synergistic multiplicity of procurement methods allows an advantaged buyer to pay to suppliers the minimum amount of money each supplier would reasonably accept for each of its products. In other words, the synergy allows advantaged buyers to practice reverse perfect price discrimination enabling the buyer to balance profit maximization versus maintaining a healthy and diversified supply chain.

In some embodiments, the marketplace is industry agnostic and is therefore suitably used in any industry and/or sub-industry. By way of non-limiting examples, in various embodiments, the marketplace is used industries involving raw materials (e.g., mining, drilling, quarrying, smelting, chemical manufacture, etc.), agriculture (e.g., farming, diary, meat, fishing, hunting, food preparation, food manufacture, etc.), construction (e.g., building, construction contracting, etc.), publishing (e.g., writing, printing, binding, etc.), textiles (e.g., textile manufacture, clothing manufacture, etc.), hospitality (e.g., restaurant operation, hotel operation, resorts, etc.), electronics (e.g., computer, mobile device, camera, stereo, and television manufacture etc.), transportation (e.g., automobile, bus, train, boat, and aircraft manufacture, freight, shipping, courier, etc.), pharmaceuticals (e.g., drug discovery, pharmaceutical manufacture, drug sales, etc.), defense (e.g., research, weapons manufacture, defense contracting, etc.), healthcare (e.g., hospitals, medical research, medical/dental/veterinary practice, etc.), consumer retail (e.g., furniture, clothing, groceries, jewelry, automobiles, lumber, electronics, media, pharmaceuticals, household goods, etc.), entertainment (e.g., music production, movie production, live entertainment, radio, broadcasting, etc.), and the like.

In some embodiments, the marketplace is cross-lingual. In further embodiments, a cross-lingual marketplace expands the size and reach of the market available to an advantaged market participant, allowing them to maximize their advantaged position. In some embodiments, the marketplace includes tools and features to allow suppliers to provide product definitions in a plurality of languages. In further embodiments, a central buyer designates a default language and product definitions are selected from a plurality based on the buyer's preferred language. In some embodiments, the marketplace includes tools and features to allow market participants to negotiate with the aid of a language translator. In further embodiments, negotiations between market participants revolve around numeric, language agnostic, parameters.

In some embodiments, the marketplaces are Internet-based. In further embodiments, the marketplaces are World Wide Web-based. In still further embodiments, the marketplaces are cloud computing-based. In some embodiments, the marketplaces are private network-based. In further embodiments, the marketplaces are intranet-based. In other embodiments, the marketplaces are based on data storage devices including, by way of non-limiting examples, CD-ROMs, DVDs, flash memory devices, magnetic disk drives, and optical disk drives.

### Buyers

Many buyers suitably participate in the marketplaces described herein. In some embodiments, a buyer is a single individual, organization, business, non-governmental organization, government agency, or entity. In other embodiments, a buyer is more than one individuals, organizations, businesses, non-governmental organizations, government agencies, or entities with a common interest. In further embodiments, a buyer is 2, 3, 4, 5, 6, 7, 8, 9, 10, 11, 12, 13, 14, 15, 16, 17, 18, 19, 20, 30, 40, 50, 60, 70, 80, 90, 100 or more individuals, organizations, businesses, government agencies, or entities with a common interest. In still further embodiments, a buyer is a group, holding company, consortium, or conglomerate. In some embodiments, a buyer invites one or more suppliers to participate in a marketplace. In further embodiments, a buyer pre-screens one or more suppliers prior to inviting them to participate in a marketplace.

### Suppliers

Many suppliers suitably participate in the marketplaces described herein. In some embodiments, a supplier is a single individual, organization, business, government agency, or entity. In other embodiments, a supplier is more than one individuals, organizations, businesses, government agencies, or entities with a common interest. In further embodiments, a supplier is 2, 3, 4, 5, 6, 7, 8, 9, 10, 11, 12, 13, 14, 15, 16, 17, 18, 19, 20, 30, 40, 50, 60, 70, 80, 90, 100 or more individuals, organizations, businesses, government agencies, or entities with a common interest. In still further embodiments, a supplier is a group, holding company, consortium, or conglomerate. In some embodiments, a supplier invites one or more buyers to participate in a marketplace. In further embodiments, a supplier pre-screens one or more buyers prior to inviting them to participate in a marketplace.

### Product Definitions

Many products are suitable for trade and/or procurement within the marketplaces described herein. In some embodiments, products are to, by way of non-limiting examples, goods, works, rights, and/or services. In further embodiments, products are not limited to any particular use or any particular industry. In some embodiments, products are commodities. In some embodiments, the marketplace is for trade and/or procurement of commodities. In further embodiments, commodities are goods only for which there is demand, but which is supplied without qualitative differentiation across a market. In still further embodiments, a commodity has full or partial fungibility; that is, the market treats it as equivalent or nearly so no matter who produces it. In some embodiments, the marketplace is for trade and/or procurement of services.

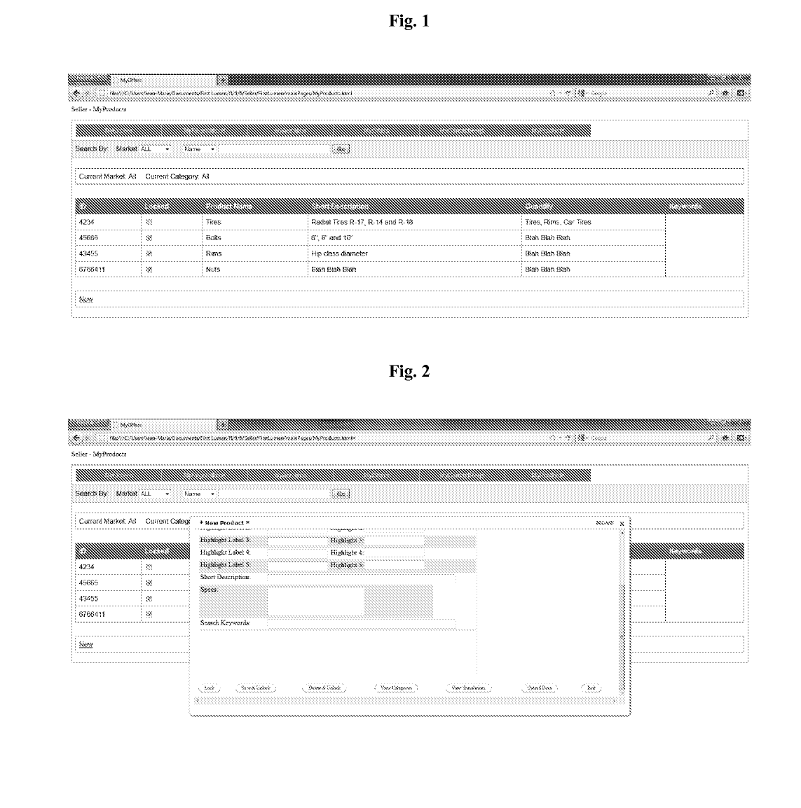

In some embodiments, the systems, media, software, applications, and methods described herein include a database of product definitions, or use of the same. In further embodiments, a product description includes, by way of non-limiting examples, a product name, a product overview, product characteristics, ratings, specifications, identifiers, part numbers, keywords, and the like. See, e.g., FIGS. 1, 2, and 16. In still further embodiments, a product description includes one or more product photographs, illustrations and/or videos. In various embodiments, a product description includes 1, 2, 3, 4, 5, 6, 7, 8, 9, 10, 20, 30, 40, 50, 60, 70, 80, 90, 100 or more product photographs, illustrations, and/or videos, including increments therein. In some embodiments, a product description includes a downloadable specification sheet. In some embodiments, a product description includes a downloadable schematic diagram, blueprint, or engineering plan. In some embodiments, a product description includes a downloadable MSDS. In some embodiments, a product description includes a summary description or a short description suitable for abbreviated description of a product on various parts of the marketplace. See, e.g., FIG. 1. In some embodiments, a product description includes the submitting supplier's current capacity to produce or provide the defined product. In some embodiments, a product description includes the submitting supplier's cost structure for producing or providing the defined product. In further embodiments, a cost structure includes costs associated with, by way of non-limiting examples, raw materials, labor, utilities, sales, marketing, transaction costs, shipping costs, tariffs, and the like. In further embodiments, a cost structure includes a projected profit margin.

In some embodiments, product definitions are created, submitted, and/or maintained by a supplier of the product. In cases where market forces favor a central buyer, responsibility for product definitions are shifted to suppliers, reducing costs and effort for the advantaged market participant.

In some embodiments, a central buyer defines product classifications or categories. In further embodiments, a central buyer defines a list of product classifications or categories. In other embodiments, a central buyer defines a hierarchy or taxonomy of product classifications or categories. In some embodiments, each supplier submitting a product definition is required to associate the defined product with one or more product classifications or categories defined by the buyer. Advantages of this requirement include, but are not limited to, improved organization, enhanced searching, and encouragement of a common vocabulary for market participants.

In some embodiments, the systems, media, software, applications, and methods described herein include a software module configured to allow submission (e.g., upload) of product definitions, or use of the same. In further embodiments, a software module configured to allow submission of product definitions is adapted for use by supplier of the product. In still further embodiments, a software module configured to allow submission of product definitions offers features for creation, saving, retrieval, editing, and deletion of product definitions. In some embodiments, a software module configured to allow submission of product definitions also allows submission (e.g., upload) of supporting materials such as images, documents, and the like described herein. In further embodiments, a software module configured to allow submission of product definitions further allows submission of, by way of non-limiting examples, the suppliers current capacity to produce or provide the defined product and the supplier's cost structure for the defined product.

In view of the disclosure provided herein, those of skill in the art will recognize that many databases are suitable for storage and retrieval of product definitions. In various embodiments, suitable databases include, by way of non-limiting examples, relational databases, non-relational databases, object oriented databases, object databases, entity-relationship model databases, associative databases, or XML databases.

In some embodiments, the software module configured to allow a supplier to submit product definitions allows a supplier to submit each product definition in a plurality of languages to facilitate the cross-lingual marketplaces described further herein. In further embodiments, each supplier creates, saves, edits, maintains, and deletes one or more translations of each product definition. In some embodiments, submission of each product definition in a plurality of language is optional. In other embodiments, submission of each product definition in a plurality of language is required.

Referring to FIG. 1, in a particular embodiment, an online private marketplace includes a GUI for a supplier to manage products and product definitions. In this embodiment, the GUI includes a list of products that is sortable and searchable. Each product is described by an ID number, a product name, a short product description, and a quantity that the supplier possesses and/or is in a position to produce or provide.

Referring to FIG. 2, in a particular embodiment, an online private marketplace includes a GUI for a supplier to manage products and product definitions. In this embodiment, the GUI includes an element to open a new product submission form. A new product submission form includes fields for entry of a product name, a short description, specifications, and keywords. Further, in this embodiment, a new product submission form includes elements to access buyer defined product categories and an element to upload associated documents.

### Offers

In some embodiments, the systems, media, software, applications, and methods described herein include a software module configured to allow a market participant to configure one or more offers, or use of the same. In further embodiments, an offer comprises one or more defined products and terms of sale for each product. In some embodiments, a market participant bundles a plurality of defined products into an offer. An offer includes any suitable number of defined products. In various embodiments, an offer includes 1, 2, 3, 4, 5, 6, 7, 8, 9, 10, 11, 12, 13, 14, 15, 16, 17, 18, 19, 20, 30, 40, 50, 60, 70, 80, 90, 100 or more defined products, including increments therein.

In some embodiments, terms of sale in an offer include, by way of non-limiting examples, product name, product description, product definition, price, quantity, shipping date, delivery date, warranty, discount, and the like, for each product. In some embodiments, an advantaged market participant creates offers. In other embodiments, one or more other (e.g., non-advantaged) market participants create offers. In yet other embodiments, both advantaged market participants and other market participants create offers. In some embodiments, an advantaged central supplier configures offers to sell. In other embodiments, an advantaged central buyer configures offers to buy.

In some embodiments, the systems, media, software, applications, and methods described herein include a software module configured to allow a market participant to view, accept, decline, and/or manage offers configured or created by another market participant, or use of the same. In some embodiments, an advantaged market participant views, accepts, declines, and/or manages offers configured or created by another (e.g., non-advantaged) market participant. In other embodiments, one or more other (e.g., non-advantaged) market participants view, accept, decline, and/or manage offers configured or created by an advantaged market participant. In other embodiments, both advantaged market participants and other market participants view, accept, decline, and/or manage offers. In some embodiments, an advantaged central supplier views, accepts, declines, and/or manages offers. In other embodiments, an advantaged central buyer views, accepts, declines, and/or manages offers.

In one embodiment, a plurality of suppliers use a software module to configure offers to sell for review by a central buyer, where asymmetrical market forces favor the buyer. In this embodiment, each offer consists of one or more product definitions and terms of sale such as price, quantity, and shipment date. In such embodiment, the central buyer uses a software module to review the offers configured by the plurality of suppliers. In some cases, the buyer optionally accepts one or more offers and completes the transaction by direct purchase. In other cases, the buyer optionally makes a counteroffer to begin a negotiation.

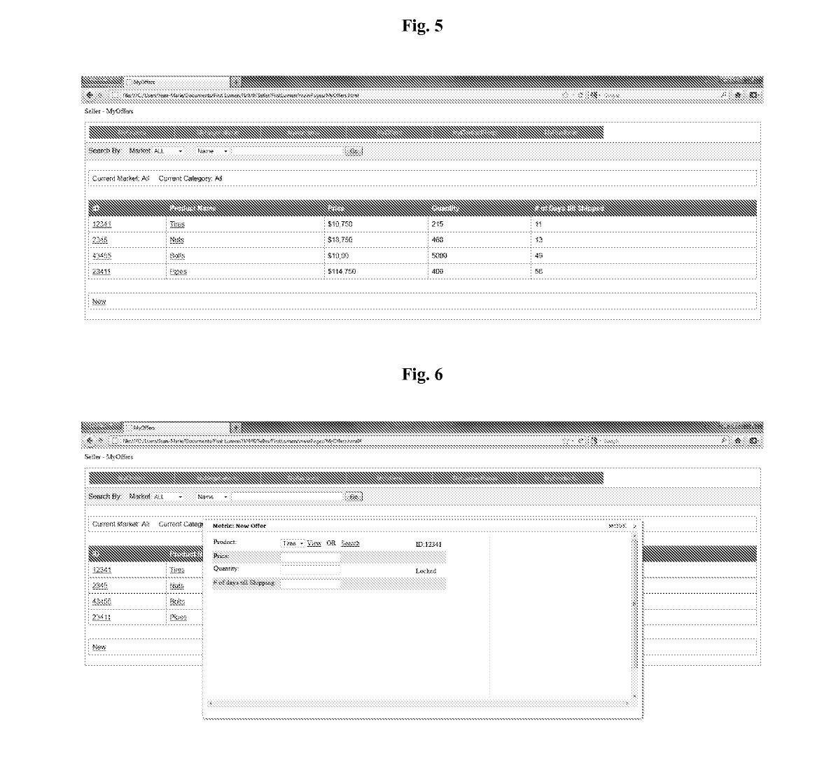

Referring to FIG. 5, in a particular embodiment, an online private marketplace includes a GUI for a supplier to view and manage offers. In this embodiment, the GUI includes a list of offers that is sortable and searchable. Each offer is described by an ID number, a product name, a price, a quantity, and a number of days until the order ships.

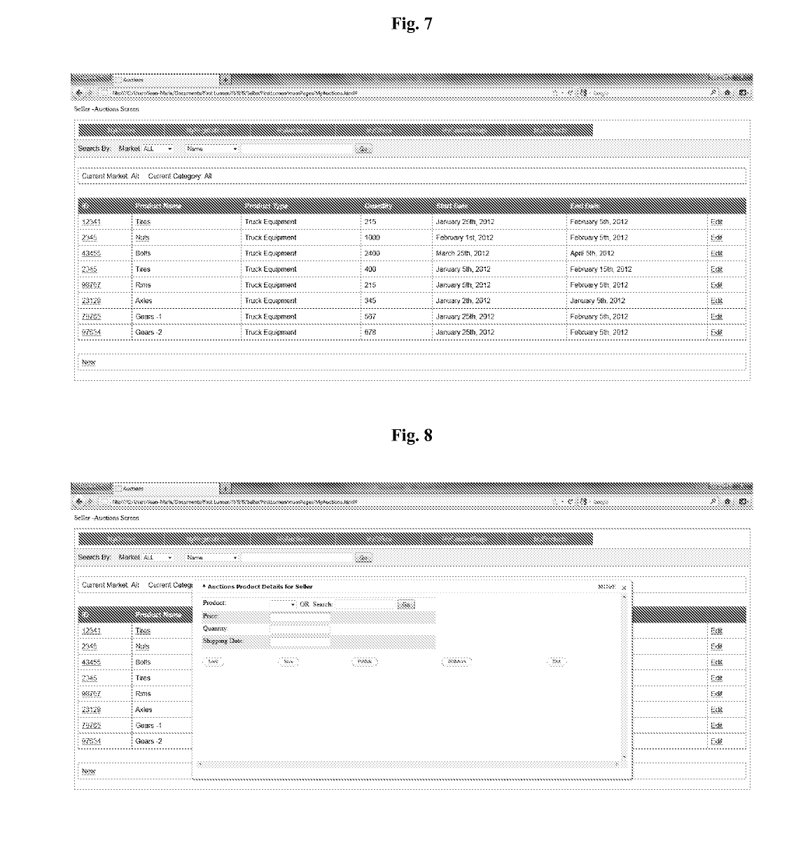

Referring to FIG. 6, in a particular embodiment, an online private marketplace includes a GUI for a supplier to view and manage offers. In this embodiment, the GUI includes an element to open a new offer submission form. A new offer submission form includes fields for entry of a product, a price, a quantity, and a number of days until the order ships.

Referring to FIG. 14, in a particular embodiment, an online private marketplace includes a GUI for a buyer to view and manage offers. In this embodiment, the GUI includes a list of offers that is sortable and searchable. Each offer is described by an ID number, a product name, a price, a quantity, and a number of days until the order ships.

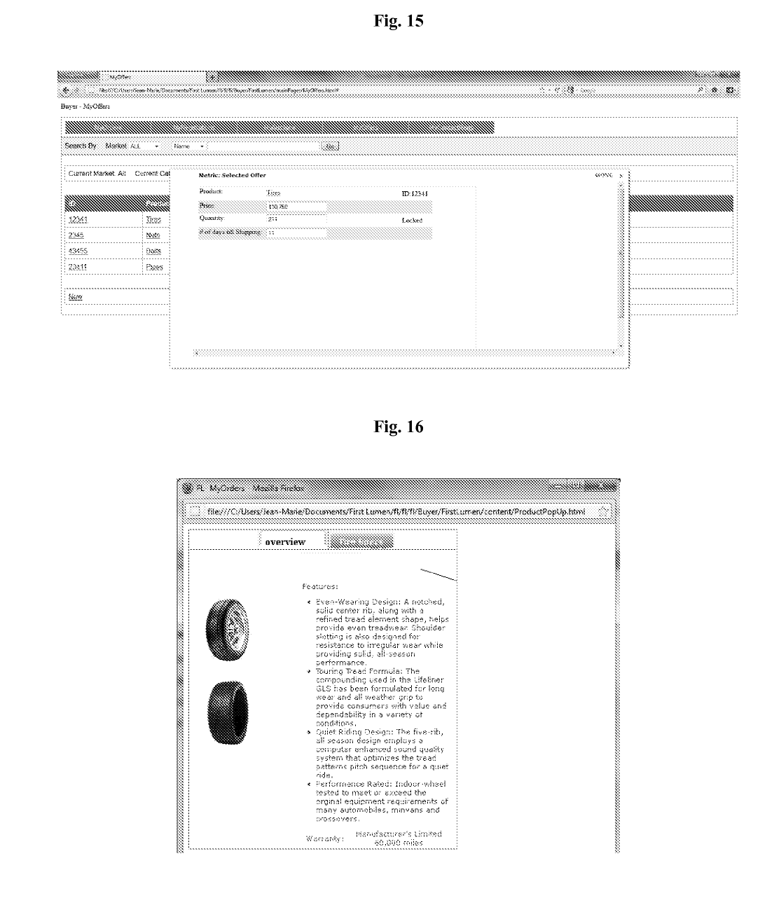

Referring to FIG. 15, in a particular embodiment, an online private marketplace includes a GUI for a buyer to view and manage offers. In this embodiment, the GUI includes an element to open an offer detail screen. An offer detail screen includes fields for product, price, quantity, and number of days until the order ships. Further, in this embodiment, a product link optionally opens a product detail screen including product photographs, specifications, and a description. See e.g., FIG. 16.

### Direct Purchase

The systems, media, software, applications, and methods described herein include, in some embodiments, a software module configured to allow procurement of products by direct purchase, or use of the same. In some embodiments, offers configured by a market participant include an element to accept the offer and purchase one or more offered products. Many methods of financial transaction are suitable for completion of a direct purchase. In various embodiments, suitable financial transactions include, by way of non-limiting examples, credit transactions, issuing a purchase order, and electronic funds transfer (EFT) including wire transfer, direct deposit, electronic check, and direct debit.

In one embodiment, a central buyer optionally accepts one or more offers to sell configured by one or more product suppliers. In another embodiment, a central supplier optionally accepts one or more offers to buy configured by one or more buyers. In yet another embodiment, a plurality of buyers optionally accept one or more offers to sell form a central supplier.

### Negotiation

The systems, media, software, applications, and methods described herein include, in some embodiments, a software module configured to allow buyers and suppliers to negotiate on the terms of sale of one or more defined products, or use of the same. In some embodiments, offers configured by a market participant include an element to make a counteroffer and begin a negotiation. In some embodiments, a software module configured to allow buyers and suppliers to negotiate on the terms of sale of one or more defined products allows a plurality of rounds of offers/counteroffers. In further embodiments, market participants make offers/counteroffers until a participant accepts an offer/counteroffer, a participant rejects an offer/counteroffer without a counteroffer, or a participant rejects the negotiation.

In some embodiments, market participants negotiate on which products are included in an offer. In further embodiments, market participants negotiate on the terms of sale of one or more products included in an offer. Many terms of sale are suitable for negotiation between market participants. In various embodiments, terms of sale suitable for negotiation include, by way of non-limiting embodiments, price, quantity, shipping date, delivery date, warranty, discount, and the like.

In some embodiments, a software module configured to allow buyers and suppliers to negotiate on the terms of sale of one or more defined products allows negotiation of numeric terms, which are language agnostic to some extent. In further embodiments, negotiable numeric terms of sale include, for example, price, quantity, and delivery date.

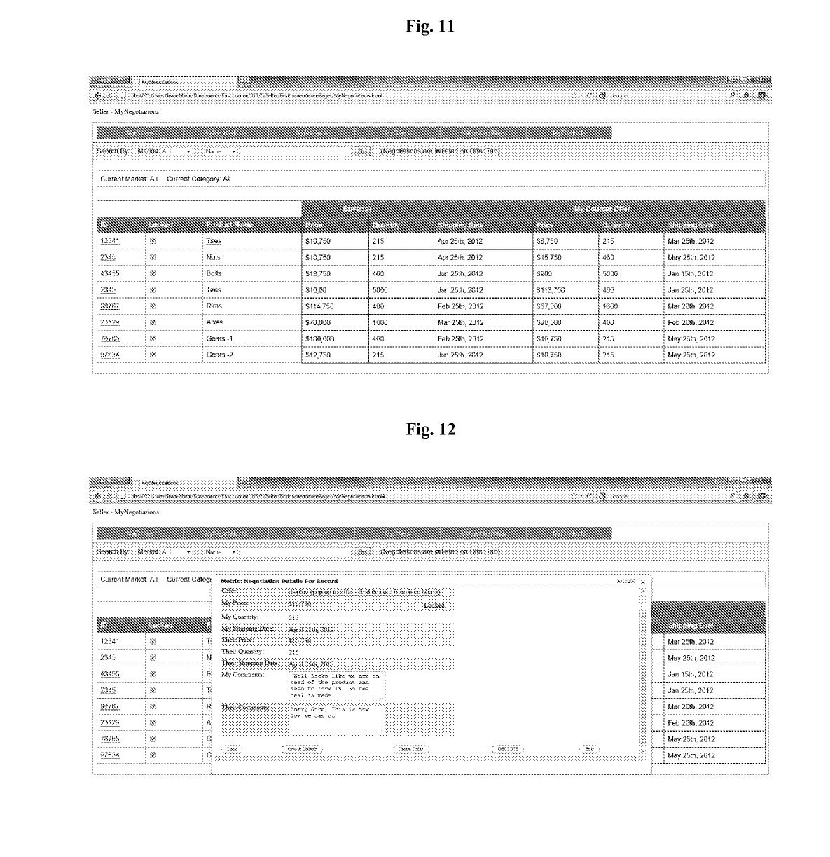

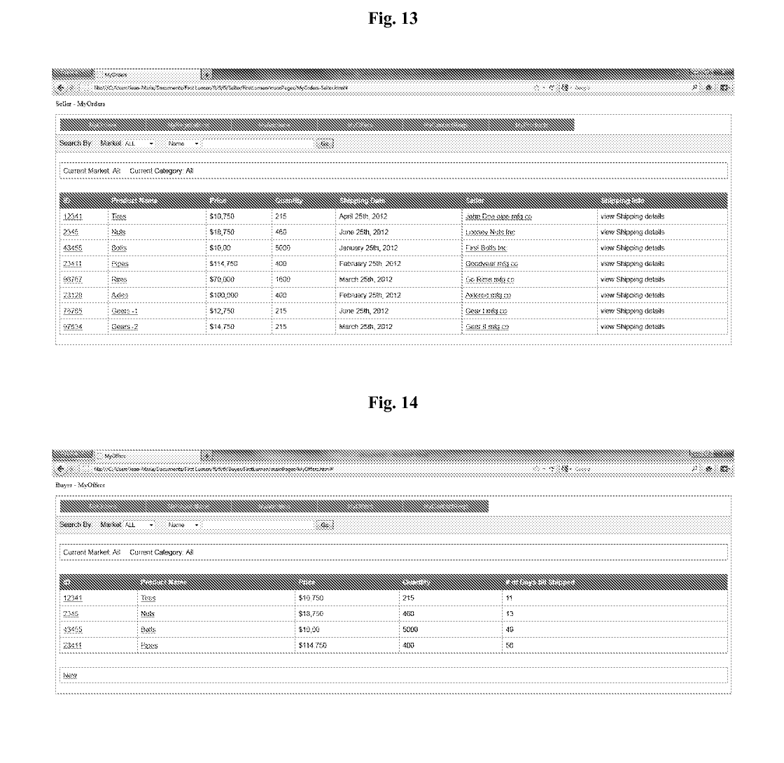

Referring to FIG. 11, in a particular embodiment, an online private marketplace includes a GUI for a supplier to review current negotiations. In this embodiment, the GUI displays a sortable and searchable list of the most recent offers/counteroffers configured by buyers. For each buyer offer/counteroffer, the GUI displays an offer ID, a product name, a price, a quantity, and a shipping date for each product. Further, in this embodiment, the GUI displays the supplier's most recent counteroffer including an associated price quantity, and shipping date.

Referring to FIG. 12, in a particular embodiment, an online private marketplace includes a GUI for a supplier to review current negotiations. In this embodiment, the GUI includes an element to display a negotiation detail screen including the supplier's most recently offered price, quantity, and shipping date as well as the buyer's most recently offered price, quantity, and shipping date. In this case, the GUI includes the most recent comments made by the participants and elements to allow a supplier to decline the most recent buyer offer.

Referring to FIG. 20, in a particular embodiment, an online private marketplace includes a GUI for a buyer to review current negotiations. In this embodiment, the GUI displays a sortable and searchable list of the most recent offers/counteroffers configured by suppliers. For each supplier offer/counteroffer, the GUI displays an offer ID, a product name, a price, a quantity, and a shipping date for each product. Further, in this embodiment, the GUI displays the buyer's most recent counteroffer including an associated price quantity, and shipping date.

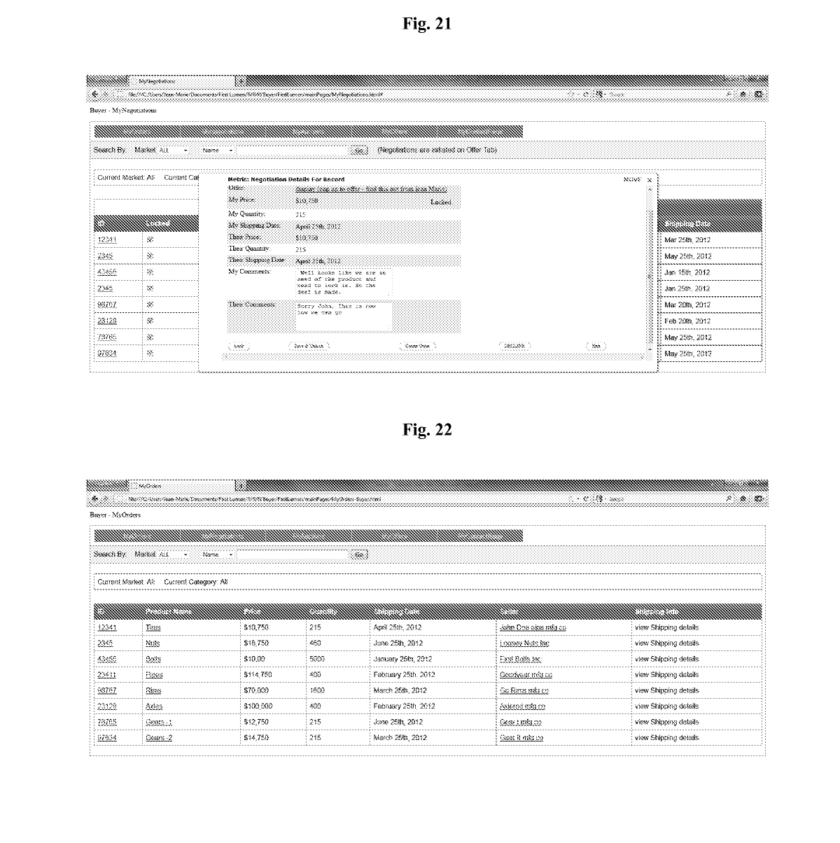

Referring to FIG. 21, in a particular embodiment, an online private marketplace includes a GUI for a buyer to review current negotiations. In this embodiment, the GUI includes an element to display a negotiation detail screen including the buyer's most recently offered price, quantity, and shipping date as well as the supplier's most recently offered price, quantity, and shipping date. In this case, the GUI includes the most recent comments made by the participants and elements to allow a buyer to decline the most recent supplier offer.

### Auction

The systems, media, software, applications, and methods described herein include, in some embodiments, a software module configured to allow procurement of products by auction, or use of the same. In some embodiments, a supplier auctions a supply of one or more defined products. In other embodiments, a buyer auctions a purchase of one or more defined products. In some embodiments, auction bidders propose prices for one or more defined products. In other embodiments, auction bidders propose quantities for one or more defined products. In yet other embodiments, auction bidders propose shipping dates for one or more defined products.

In some embodiments, a software module for auctioning is configured to allow a supplier to conduct auctions. In further embodiments, a supplier utilizes a software module configured to allow procurement of products by auction to conduct a forward auction, wherein buyers compete to obtain products from the supplier by offering terms increasingly favorable to the supplier.

In some embodiments, a software module for auctioning is configured to allow a buyer to conduct auctions. In further embodiments, a buyer utilizes a software module configured to allow procurement of products by auction to conduct a reverse auction, wherein suppliers compete to provide products to the buyer by offering terms increasingly favorable to the buyer.

Referring to FIG. 7, in a particular embodiment, an online private marketplace includes a GUI for a supplier to review current auctions. In this embodiment, the GUI displays a sortable and searchable list of open auctions configured by the supplier. For each auction, the GUI displays an auction ID, a product name, a product type, a quantity, an auction start date, and an auction end date.

Referring to FIG. 8, in a particular embodiment, an online private marketplace includes a GUI for a supplier to review current auctions. In this embodiment, the GUI includes an element to display a product detail screen for an auction. Further, in this embodiment, a product detail screen allows a supplier to configure a product that is the subject matter of an auction including a price, a quantity, and a shipping date.

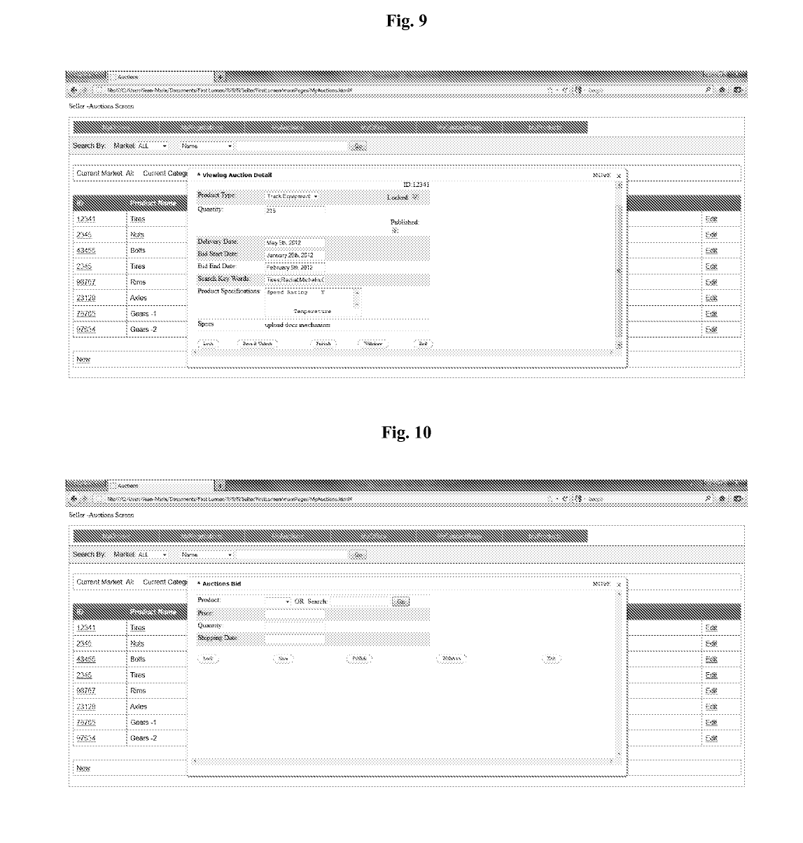

Referring to FIG. 9, in a particular embodiment, an online private marketplace includes a GUI for a supplier to review current auctions. In this embodiment, the GUI includes an element to display an auction detail screen. Further, in this embodiment, an auction detail screen allows a supplier to configure an auction including parameters such as product type, quantity, delivery date, bid start date, bid end date, key words, product specifications, and product description.

Referring to FIG. 10, in a particular embodiment, an online private marketplace includes a GUI for a supplier to bid in current auctions. In this embodiment, the GUI includes an element to display an auction bid screen. Further, in this embodiment, a bid screen includes fields for a supplier to configure bid parameters such as product, price, quantity, and shipping date.

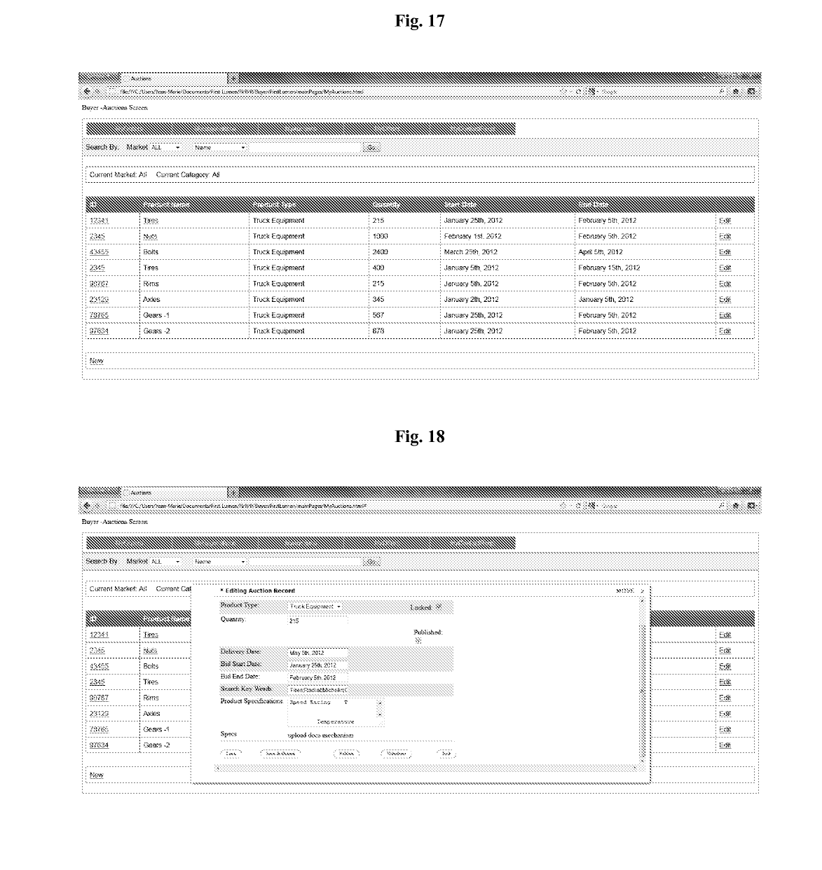

Referring to FIG. 17, in a particular embodiment, an online private marketplace includes a GUI for a buyer to review current auctions. In this embodiment, the GUI displays a sortable and searchable list of open auctions configured by the buyer. For each auction, the GUI displays an auction ID, a product name, a product type, a quantity, an auction start date, and an auction end date.

Referring to FIG. 18, in a particular embodiment, an online private marketplace includes a GUI for a buyer to review current auctions. In this embodiment, the GUI includes an element to display an auction detail screen. Further, in this embodiment, an auction detail screen allows a buyer to configure an auction including parameters such as product type, quantity, delivery date, bid start date, bid end date, key words, product specifications, and product description.

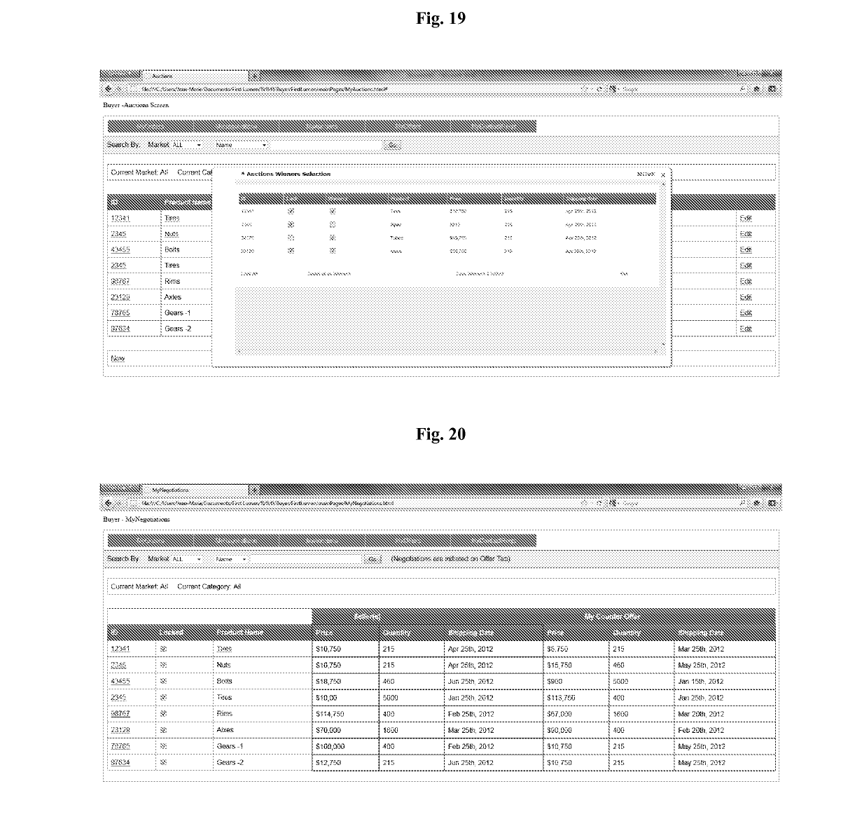

Referring to FIG. 19, in a particular embodiment, an online private marketplace includes a GUI for a buyer to review current auctions. In this embodiment, the GUI includes an element to display a screen to allow a buyer to select auction winners.

### Contextual Ticker

The systems, media, software, applications, and methods described herein include, in some embodiments, a software module configured to provide a contextual sale information ticker, or use of the same. In further embodiments, a contextual sale information ticker displays information on recent commerce (e.g., transactions, sales, etc.) in the marketplace. In some embodiments, a contextual sale information ticker is configured by an advantaged market participant and is displayed to other (e.g., non-advantaged) market participants. In further embodiments, a contextual sale information ticker is configured by a central supplier and is displayed to one or more buyers. In other embodiments, a contextual sale information ticker is configured by a central buyer and is displayed to one or more suppliers.

In some embodiments, a contextual sale information ticker fosters increased competition by putting market participants on notice that they did not land a contract. In further embodiments, a contextual sale information ticker selectively encourages market participants to configure competitive offers and participate in auctions and negotiations in a competitive manner. For example, a supplier who sees several purchases of parts it sells from other vendors will automatically know that it must take steps to be more competitive.

In some embodiments, a contextual sale information ticker contextual and the information it displays is customized. In further embodiments, a contextual sale information ticker displays different information to each participant based on, for example, the participant's, industry, sector, products defined, products sold, products bought, and the like. By way of example, information displayed by a ticker described herein is limited to recent sales of products sold by a particular supplier. By way of further example, a ticker informs suppliers about recent transactions in their sector. In other embodiments, information displayed by a ticker described herein is limited to recent sales designated by an advantaged market participant. By way of example, upon completion of a purchase, a central buyer optionally designates one or more specific suppliers to receive information on the transaction via a ticker described herein.

A wide range of sale information is suitable for display by a contextual sale information ticker. In various embodiments, suitable sale information includes, by way of non-limiting example, sale date, bundled products, product name, product definition, product specifications, quantity, price, discount, shipping date, buyer name, seller name, buyer logo, seller logo, related sales, and the like.

A contextual sale information ticker described herein suitably displays information in a wide range of styles. In various embodiments, information is suitably displayed statically, scrolled horizontally, scrolled vertically, flashed on a display, and the like. In other embodiments, information is suitably presented in audio format, video format, or multimedia format.

A contextual sale information ticker described herein is suitably integrated in a wide range of locations within the marketplaces described herein. In some embodiments, a ticker is displayed on a dashboard configured for a market participant. In various embodiments, a ticker is displayed in a header, footer, status bar, or on a tab of a GUI. In other embodiments, a contextual sale information ticker described herein is provided as a mobile application, a standalone application, or web browser extension, plug-in, add-in, or add-on.

### Cross-Lingual

In some embodiments, the marketplace is cross-lingual. In further embodiments, a cross-lingual marketplace is one in which at least one participant transacts with someone that predominantly or only speaks a language other than their own. In some embodiments, a cross-lingual marketplace expands the size and reach of the market available to an advantaged market participant, allowing them to maximize their advantaged position. In some embodiments, a central (e.g., advantaged) buyer or supplier selects a default language. Many languages are suitable for use in the marketplaces described herein including, by way of non-limiting examples, English, Spanish, Italian, Portuguese, French, Dutch, Polish, German, Russian, Ukrainian, Mandarin, Wu, Cantonese, Hindi, Punjabi, Bengali, Marathi, Urdu, Arabic, Turkish, Tamil, Farsi, Japanese, Korean, Vietnamese, That, Burmese, Malay, Telugu, Javanese, Tagalog, and dialects thereof. In further embodiments, where content, such as product definitions, are provided in a plurality of languages, the marketplaces described herein will display the content in the market participant's default language.

In some embodiments, the marketplace includes tools and features to allow suppliers to optionally provide product definitions in a plurality of languages. In various embodiments, a supplier provides product definitions in 1, 2, 3, 4, 5, 6, 7, 8, 9, 10, 11, 12, 13, 14, 15, 16, 17, 18, 19, 20 or more languages.

In some embodiments, the marketplace includes tools and features to allow market participants to chat and/or negotiate with the aid of a language translator. In further embodiments, a language translator is utilized in a pre-scheduled chat session or negotiation. In other embodiments, a language translator is utilized in an on-demand chat session or negotiation, which is not pre-scheduled. In some cases, the services of a language translator are provided by the operator of the marketplace. In other cases, the services of a language translator are provided by a market participant. In some embodiments, negotiations between market participants revolve around numeric, language agnostic, parameters.

### Contact and Communications

The systems, media, software, applications, and methods described herein include, in some embodiments, tools and features to facilitate contact and communication between market participants. In some embodiments systems, media, software, applications, and methods described herein include a software module configured to allow chat sessions between market participants. In further embodiments, chat sessions are synchronous, real-time, or substantially real-time (e.g., instant messaging, etc.). In other embodiments, chat sessions are asynchronous. In some embodiments, a software module configured to allow chat sessions between market participants allows chat sessions between two participants. In other various embodiments, a software module configured to allow chat sessions between market participants allows chat sessions between 3, 4, 5, 6, 7, 8, 9, 10, 11, 12, 13, 14, 15, 16, 17, 18, 19, 20 or more participants. In further embodiments, a software module configured to allow chat sessions between market participants allows chat sessions between including a language translator.

In some embodiments systems, media, software, applications, and methods described herein include a software module configured to allow a market participant to make a request to contact another participant. In some embodiments, an advantaged market participant requests contact with one or more other (e.g., non-advantaged) market participants. In some embodiments, a non-advantaged market participant requests contact with an advantaged market participant. In further embodiments, a central supplier requests contact with one or more buyers. In other embodiments, a central buyer requests contact with one or more suppliers. In some embodiments, a supplier requests contact with a central (e.g., advantaged) buyer. In some embodiments, a buyer requests contact with a central (e.g., advantaged) seller.

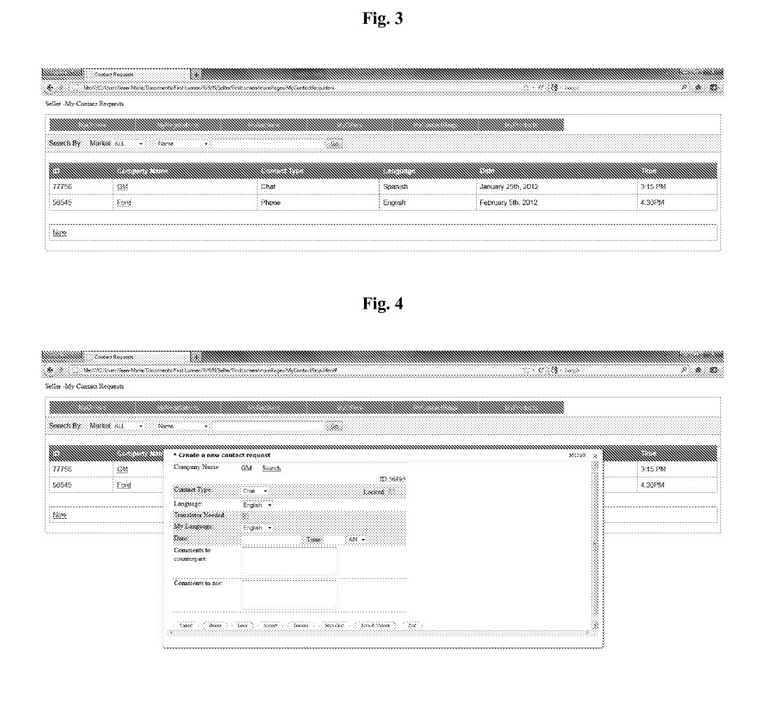

Referring to FIG. 3, in a particular embodiment, an online private marketplace includes a GUI for a supplier to review contact requests. In this embodiment, the GUI includes a searchable and sortable list of requests for contact that the supplier has made. Further, in this embodiment, a GUI for a supplier to review contact requests include, for each request, a request ID, a company name, a contact type (e.g., phone, chat, email, video conference, in person meeting, etc.), preferred language, need for a translator, date, and time.

Referring to FIG. 4, in a particular embodiment, an online private marketplace includes a GUI for a supplier to review contact requests. In this embodiment, the GUI includes an element to display a new contact request screen. Further, in this embodiment, a new contact request screen includes fields for company name, contact type, language, need for a translator, preferred language, date, time, comments, and the like.

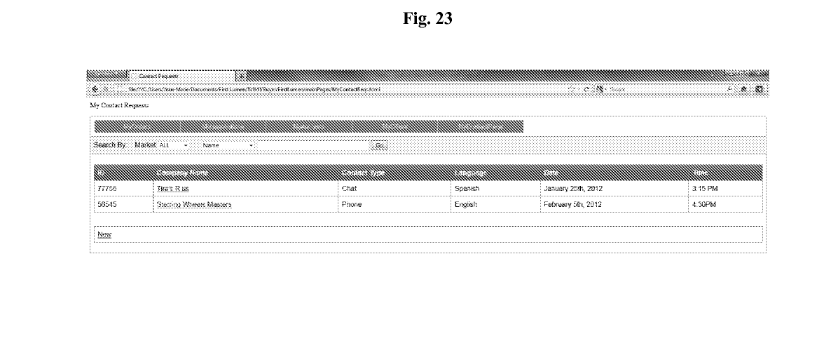

Referring to FIG. 23, in a particular embodiment, an online private marketplace includes a GUI for a buyer to review contact requests. In this embodiment, the GUI includes a searchable and sortable list of requests for contact that the buyer has made. Further, in this embodiment, a GUI for a buyer to review contact requests include, for each request, a request ID, a company name, a contact type (e.g., phone, chat, email, video conference, in person meeting, etc.), preferred language, need for a translator, date, and time.

In some embodiments, the systems, media, software, applications, and methods described herein include a software module configured to aggregate communications related to a transaction and associate them with a transaction such that they are easily located, retrieved, and shared with authorized personnel. In further embodiments, the software module configured to aggregate communications related to a transaction and associate them with a transaction aggregates one or more types of communications related to a transaction. In still further embodiments, the software module aggregates, for example, one or more of: offers, counteroffers, negotiations (e.g., offers, counteroffers, final disposition, invoice, etc.), direct purchase records, auction records (e.g., listing, bids, final disposition, invoice, etc.), chat sessions, emails, contact requests, and the like. In other embodiments, the software module aggregates all types of communications related to a transaction.

In some embodiments, the software module configured to aggregate communications related to a transaction and associate them with a transaction associates communications with pending transactions (e.g., those not completed), associating communications as they are made. In other embodiments, the software module configured to aggregate communications related to a transaction and associate them with a transaction associates communications with completed transactions. In further embodiments, the communications are attached to the transaction invoice.

In some embodiments, aggregated communications associated with a transaction are viewable by all users associated with the transaction. In further embodiments, aggregated communications associated with a transaction are viewable by, for example, the sender of the communication and the recipients of the communication. In still further embodiments, aggregated communications associated with a transaction are viewable by, for example, users associated with a group or team to which the sender of the communication and the recipients of the communication belong. In still further embodiments, aggregated communications associated with a transaction are viewable by, for example, users associated with an account, entity, buyer, or seller, with which the sender of the communication and the recipients of the communication are associated. In some embodiments, aggregated communications associated with a transaction are viewable by individuals associated with a group, team, entity, buyer, or seller that was a party to the transaction.

In some embodiments, a software module configured to aggregate communications related to a transaction and associate them with a transaction creates transparency and preserves institutional knowledge of previous experiences with a particular buyer, seller, or individual.

### Groups and Teams

In some embodiments, the systems, media, software, applications, and methods described herein include a software module configured to define a group or a team of users. In further embodiments, a software module configured to define a group or a team of users operates automatically to define groups or teams based on, for example, user association with a particular buyer, seller, or transaction. In other embodiments, a software module configured to define a group or a team of users operates manually, wherein an organizing user selects individuals to add to, or remove from, a group or team of users.

In some embodiments, membership in a group or team of users is utilized to assign privileges within a marketplace described herein. In further embodiments, membership in a group or team of users is utilized to assign privileges to, for example, make an offer, make a counteroffer, participate in negotiations, start an auction, bid in an auction, make a direct purchase, engage in chat, or view communications associated with a transaction. In further embodiments, communications associated with a transaction are viewable only by users associated with a particular group or team of users.

### Digital Processing Device

In some embodiments, the systems, media, software, applications, and methods described herein include a digital processing device, or use of the same. In further embodiments, the digital processing device includes one or more hardware central processing units (CPU) that carry out the device's functions. In some embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X°, UNIX°, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS°, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the systems, media, software, applications, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, systems, media, software, applications, and methods disclosed herein include at least one computer program. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

The systems, media, software, applications, and methods disclosed herein include, in various embodiments, software, server, and database modules. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### EXAMPLES

The following illustrative examples are representative of embodiments of the software applications, systems, and methods described herein and are not meant to be limiting in any way.

### Example 1

### Central Buyer in a Private Marketplace

A multinational automobile manufacturer enjoys high demand and strong sales for their line of plug-in electric automobiles. The automobile manufacturer's market position, reputation, growth, innovation, and volume of business create a strong advantage for them in markets in which they procure their materials and parts. In order to capitalize on this advantage without driving their suppliers out of business in the process, the automobile manufacturer builds a web application that provides a private marketplace for e-procurement described herein.

The automobile manufacturer uses a module of the application to screen all of the suppliers that they have worked with in the past five years based on internal satisfaction surveys and performance history. The automobile manufacturer further uses the module to invite a select group of approximately 250 suppliers to participate in the marketplace. Invitations are automated and sent via email containing a unique username and password assigned to each supplier. The automobile manufacturer further configures a taxonomy of product classifications that encompasses the range of products needed to create their product.

Each participating supplier logs into the marketplace using their provided credentials and uses a module to configure definitions for each product they would like to offer for sale to the automobile manufacturer. One particular tire supplier in the United States enters product definitions for five models of tires that the automobile manufacturer has previously purchased. For each product the tire supplier selects an appropriate classification in the buyer's taxonomy and uses the module to upload a description, specs, photos, internal testing data, and industry articles praising the safety and durability of their tires. The tire supplier also uploads their cost structure for each model and their current capacity to supply each model. Because the automobile manufacturer has major plants in both the United States and Japan, the supplier provides the product definitions, including the cost structures, in both English and Japanese (as well as several other languages). These are included in the marketplace's database of product definitions.

The tire supplier further uses a module to configure an offer for each model of tire as well as a bundled offer including three of the models. Each offer includes the name of the product, the product definition, a quantity, and a shipping date. These are included in the marketplace's database of offers.

The automobile manufacturer's procurement division in Japan reviews the tires offered in the marketplace. They make significant purchases from two tire suppliers in Canada, not electing to accept or negotiate the offers by the U.S. tire supplier mentioned above. The automobile manufacturer uses a module to activate a contextual sale information ticker and designates that price and quantity information for all tire sales be displayed to the U.S. tire supplier.

The U.S. tire supplier observes the tire sales being made and realizes that the Canadian suppliers are undercutting their pricing. The U.S. tire supplier uses the module again to edit their offers, shaving their profit margin down and adjusting the included cost structure accordingly. The same day that the U.S. tire supplier adjusts their offers, the automobile manufacturer's procurement officer in Japan begins a negotiation with the supplier by using a module to make a counteroffer, leaving the pricing as offered, but proposing an earlier shipping date. The parties use a module to schedule a real-time, three-way chat session including a language translator provided by the supplier. They quickly reach an agreement on a negotiated sale. The transaction is consummated by the automobile manufacturer issuing a purchase order to the tire supplier.

### Example 2

### Central Supplier in an Open Marketplace

A U.S. maker of GPS hardware and software has few competitors and is experiencing tremendous demand and for its products amid proliferation of location devices and services integrated in automobiles, mobile phones, and dedicated handheld devices. In order to maximize this advantage, the GPS hardware and software supplier builds a web application that provides a marketplace for e-procurement described herein. The marketplace is configured as an open market, available to all potential buyers. The marketplace also includes a linked mobile application to enable buyers to act quickly in purchasing, from a wide range of environments, and around the clock.

The GPS supplier uses a module to configure product definitions for their entire catalog of hardware and software, which are uploaded to the marketplace's database of products. Each product definition includes detailed descriptions, schematics, and specs. Because the central supplier has high production capacity and wishes to sell worldwide, the supplier uploads their product definitions in 15 different languages.

The supplier advertises their marketplace in appropriate trade publications. Each potential buyer logs into the marketplace and configures a buyer profile including preferred language, business, and credit information. While many buyers configure offers to buy the suppliers products. The supplier finds it most advantageous to auction blocks of products as they are manufactured and tested. Each buyer is displayed product definitions in their preferred language and the auctions revolve around language agnostic variables such as price and quantity. Many auctions include hundreds of bidders from around the world and the supplier enjoys fierce competition for their products.

One active and successful buyer makes a contact requests to the supplier using a module provided in the marketplace. In private chat sessions the parties discuss a desirable custom bundle of hardware and software products. After agreeing on some basic parameters, using recent auction data to determine supported pricing, the buyer configures an offer to buy a particular bundle of products. After three rounds of negotiations on quantity and shipping date, the supplier accepts the customized and negotiated offer to buy.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented system comprising:
a. a digital processing device comprising an operating system configured to perform executable instructions and a memory device;
b. a computer program including instructions executable by the digital processing device to create a marketplace for a central buyer comprising:
i. a database of product definitions, wherein each definition is submitted by a supplier of the product;
ii. a software module configured to allow the central buyer and one or more suppliers to negotiate on the terms of sale of one or more defined products; and
iii. a software module configured to provide a contextual sale information ticker.

2.-4. (canceled)

5. The system of claim 1, wherein the marketplace is a private marketplace and each supplier is pre-screened and invited to participate in the marketplace by the central buyer.

6. (canceled)

7. The system of claim 1, wherein the software module configured to allow the central buyer and one or more suppliers to negotiate on the terms of sale of one or more defined products allows negotiation one or more of: price, quantity, and delivery date.

8. (canceled)

9. The system of claim 1, wherein the marketplace further comprises a software module configured to allow a central buyer to procure products from the suppliers by direct purchase and by reverse auction.

10.-12. (canceled)

13. The system of claim 1, wherein the marketplace further comprises a software module configured to allow a supplier to submit product definitions.

14. (canceled)

15. The system of claim 13, wherein the software module configured to allow a supplier to submit product definitions allows each product definition to be associated with a current capacity or a cost structure.

16. (canceled)

17. The system of claim 13, wherein the software module configured to allow a supplier to submit product definitions allows a supplier to submit each product definition in a plurality of languages.

18. The system of claim 1, wherein the marketplace further comprises a software module configured to create a chat session between the central buyer, one or more suppliers and one or more language translators.

19.-20. (canceled)

21. The system of claim 1, wherein the marketplace further comprises a software module configured to aggregate all communications related to a transaction and associate them with a pending or completed transaction.

22. (canceled)

23. The system of claim 1, wherein the contextual sale information ticker displays information on recent sales made in the marketplace, wherein the ticker displays the information to suppliers.

24. The system of claim 23, wherein the contextual sale information ticker displays information to each supplier participating in the marketplace that is limited to information on recent sales of products sold by each particular supplier.

25.-79. (canceled)

80. A computer-implemented method for e-procurement comprising the steps of:
a. screening, by a central buyer, one or more product suppliers;
b. inviting one or more screened product suppliers to participate in a private online marketplace;
c. reviewing product definitions created by each product supplier, wherein the product definitions are stored in a computer memory;
d. providing, by one or more processors, a contextual sale information ticker to each product supplier; and
e. purchasing, by one or more processors, one or more defined products by direct purchase, reverse auction, or negotiated purchase.

81. A computer-implemented system comprising:
a. a digital processing device comprising an operating system configured to perform executable instructions and a memory device;
b. a computer program including instructions executable by the digital processing device to create a marketplace for a central supplier comprising:
i. a database of buyers;
ii. a database of product definitions, wherein each definition is submitted by the central supplier;
iii. a software module configured to allow the central seller and one or more buyers to negotiate on the terms of sale of one or more defined products; and
iv. a software module configured to provide a contextual sale information ticker.

82.-83. (canceled)

84. The system of claim 81, wherein the marketplace is a private marketplace and each buyer is pre-screened and invited to participate in the marketplace by the central supplier.

85. (canceled)

86. The system of claim 81, wherein the software module configured to allow the central supplier and one or more buyers to negotiate on the terms of sale of one or more defined products allows negotiation one or more of: price, quantity, and delivery date.

87. (canceled)

88. The system of claim 81, wherein the marketplace further comprises a software module configured to allow a central supplier to sell products by direct purchase and by auction.

89.-91. (canceled)

92. The system of claim 81, wherein the marketplace further comprises a software module configured to allow a supplier to submit product definitions.

93. (canceled)

94. The system of claim 81, wherein the marketplace further comprises a software module configured to create a chat session between the central supplier, one or more buyers and one or more language translators.

95.-96. (canceled)

97. The system of claim 81, wherein the marketplace further comprises a software module configured to aggregate all communications related to a transaction and associate them with a pending or completed transaction.

98. (canceled)

99. The system of claim 81, wherein the contextual sale information ticker displays information on recent sales made in the marketplace, wherein the ticker displays the information to buyers.

100.-104. (canceled)

105. A computer-implemented method for e-procurement comprising the steps of:
a. screening, by a central supplier, one or more buyers;
b. inviting one or more screened buyers to participate in a private online marketplace;
c. uploading product definitions created by the central supplier, wherein the product definitions are stored in a computer memory;
d. providing, by one or more processors, a contextual sale information ticker to each buyer; and
e. selling, by one or more processors, one or more defined products by direct sale, auction, or negotiated sale.
